(19) United States
(12) Patent Application Publication
(10) Pub. No.: US 2019/0379429 A1
(43) Pub. Date: Dec. 12, 2019

(54) MIMO ANTENNA SYSTEM AND CONTROLLING METHOD THEREOF

(71) Applicant: INDUSTRIAL TECHNOLOGY RESEARCH INSTITUTE, Hsinchu (TW)

(72) Inventors: Hsien-Wen CHANG, Hsinchu City (TW); Chih-Yu CHEN, Yilan City (TW); Shih-Hao FANG, Zhubei City (TW); Jen-Yuan HSU, Jincheng Township (TW)

(73) Assignee: INDUSTRIAL TECHNOLOGY RESEARCH INSTITUTE, Hsinchu (TW)

(21) Appl. No.: 16/178,847

(22) Filed: Nov. 2, 2018

(30) Foreign Application Priority Data
Jun. 6, 2018 (TW) 107119552

(51) Int. Cl. H04B 7/0426; H04B 7/06; H01Q 3/36

(52) U.S. Cl. CPC H04B 7/043; H01Q 3/36; H04B 7/0608; H04B 7/0691

(57) ABSTRACT

A MIMO antenna system and a controlling method thereof are provided. The MIMO antenna system includes a first beam configuration device, a second beam configuration device and a controlling device. The first beam configuration device is used for performing an antenna selection procedure on a plurality of antennas to adjust a beam direction. The second beam configuration device is connected to the first beam configuration device. The second beam configuration device is used for performing a phase shifting procedure to adjust a beam coverage. The controlling device is used for controlling the first beam configuration device and the second beam configuration device.

This application claims the benefit of Taiwan application Serial No. 107119552, filed Jun. 6, 2018, the disclosure of which is incorporated by reference herein in its entirety.

### TECHNICAL FIELD

The disclosure relates in general to a MIMO antenna system and a controlling method thereof.

### BACKGROUND

Along with the development of the wireless communication technology, various communication systems are invented. 5G system may adopt some advanced technology, such as MIMO system, Millimeter Wave (mmWave) and Heterogeneous Network (HetNet).

In the MIMO system, it faces some problems. For example, in the case of using a smart antenna (or a lens array) to perform an antenna selection procedure for selecting beams, the beam coverage is fixed, and a narrow beam cannot be formed without bigger and more expensive array.

In the case of using a phase adjuster to form the beam, for increasing the gain of the beam, the number of the phase adjusters must be increased and the cost is increased exponentially. Those problems became a bottleneck of the development of the MIMO antenna technology.

### SUMMARY

The disclosure is directed to a MIMO antenna system and a controlling method thereof. A first beam configuration device and a second beam configuration device are used for performing an antenna selection procedure and a phase shifting procedure to adjust a beam direction and a beam coverage. As such, a precise beam can be obtained.

According to one embodiment, a MIMO antenna system is provided. The MIMO antenna system includes a first beam configuration device, a second beam configuration device and a controlling device. The first beam configuration device is used for performing an antenna selection procedure on a plurality of antennas to adjust a beam direction. The second beam configuration device is connected to the first beam configuration device. The second beam configuration device is used for performing a phase shifting procedure to adjust a beam coverage. The controlling device is used for controlling the first beam configuration device and the second beam configuration device.

According to another embodiment, a controlling method of a MIMO antenna system is provided. The controlling method includes the following steps. A first beam configuration device is controlled to perform an antenna selection procedure on a plurality of antennas to adjust a beam direction. A second beam configuration device is controlled to perform a phase shifting procedure to adjust a beam coverage. The second beam configuration device is connected to the first beam configuration device.

### BRIEF DESCRIPTION OF THE DRAWINGS

FIG. 1 shows a MIMO antenna system.

FIG. 2 shows a flowchart of a controlling method of the MIMO antenna system according to one embodiment.

FIG. 3 shows a MIMO antenna system according to one embodiment.

FIG. 4 shows a MIMO antenna system according to another embodiment.

FIG. 5 shows a MIMO antenna system according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

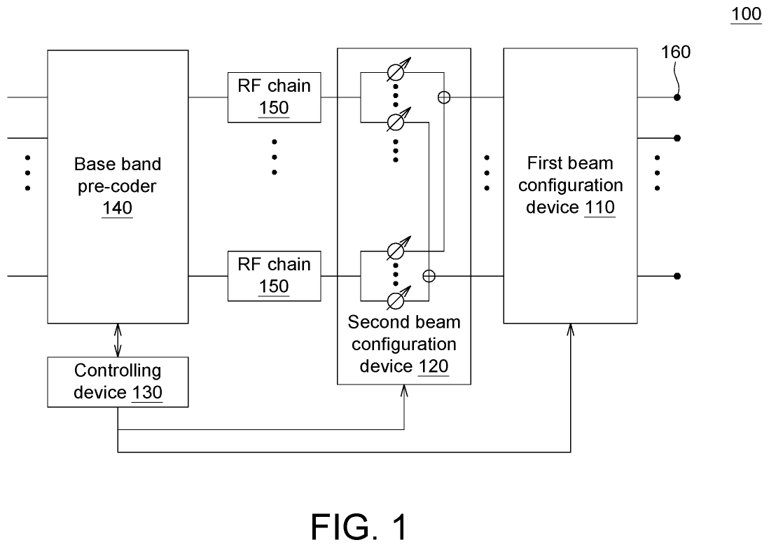

Please refer to FIG. 1, which shows a MIMO antenna system 100. The MIMO antenna system 100 includes a base band pre-coder 140, L RF chains 150, a first beam configuration device 110, a second beam configuration device 120, a controlling device 130 and N antennas 160. The base band pre-coder 140 is used for performing linear pre-coding or non-linear pre-coding on signals, to provide the L RF chains 150. The non-linear pre-coding may be dirty-paper-coding (DPC) or vector perturbation (VP), and the linear pre-coding may be Matched-Filter Pre-coding, Zero-forcing Precoding or Conjugate Beamforming, but the invention is not limited thereto.

The first beam configuration device 110 is used for performing an antenna selection procedure on N antennas 160 to adjust a beam direction. For example, the first beam configuration device 110 may be a smart antenna array, a phase shifter array or a lens array. During the antenna selection procedure, the first beam configuration device 110 may select some of the antennas 160 to control the beam direction, for instance U antennas. Or, during the antenna selection procedure, the first beam configuration device 110 may increase or decrease the number of the selected antennas 160 to control the beam project distance. Generally, under the identical energy, if the number of the antennas 160 is decreased, the beam project distance is lengthened.

The second beam configuration device 120 is used for performing a phase shifting procedure to adjust a beam coverage. For example, the second beam configuration device 120 may be a phase shifter array. The second beam configuration device 120 may decentralize the energy distribution to enlarge the beam coverage; or, the second beam configuration device 120 may centralize the energy distribution to narrow the beam coverage, and enhance the central gain of the beam. In one embodiment, the first beam configuration device 110 and the second beam configuration device 120 may be integrated to be an analog beamformer.

The controlling device 130 is used for controlling the first beam configuration device 110 and the second beam configuration device 120 to perform the above operations. For example, the controlling device 130 may be a circuit, a circuit board, a chip, a computer or a storage device storing a plurality of program codes, but the invention is not limited thereto. The operation of the above elements is illustrated via a flowchart.

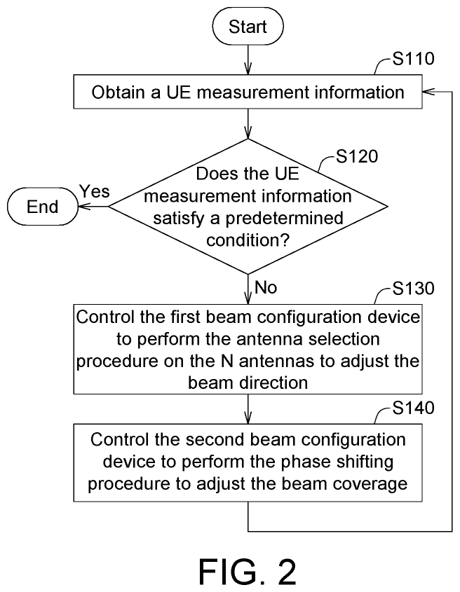

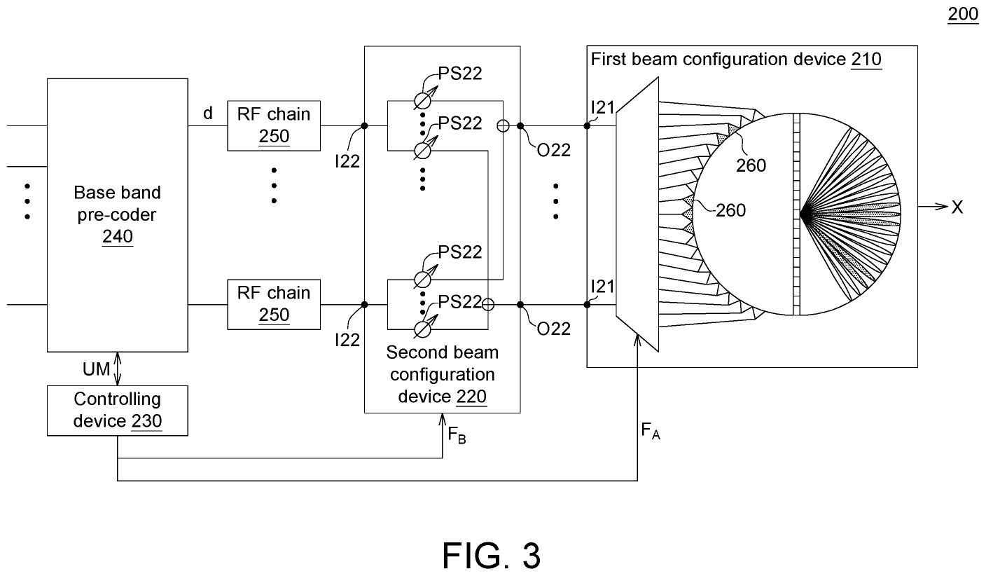

Please refer to FIGS. 2 and 3. FIG. 2 shows a flowchart of a controlling method of the MIMO antenna system according to one embodiment, and FIG. 3 shows a MIMO antenna system 200 according to one embodiment. In the embodiment of FIG. 3, a base band pre-coder 240 provides L RF chains 250. A matrix d of the L RF chains 250 is

$$[ \begin{matrix}{d}_{1} \\ ⋮ \\ {d}_{L}\end{matrix} ] ,$$

where d1 to dL are precoded data for the L RF chains 250. The signals of the L RF chains 250 form a particular beam via a first beam configuration device 210 and a second beam configuration device 220. In the embodiment of FIG. 3, the first beam configuration device 210 is a time-delay-based discrete lens array, and the second beam configuration device 220 is a fully-connected phase shifter array.

Firstly, in step S110, the controlling device 230 obtains a UE measurement information UM. In the step S110, the controlling device 230 knows the signal situation of the MIMO antenna system 200 according to the UE measurement information UM.

Next, in step S120, the controlling device 230 determines whether the UE measurement information UM satisfies a predetermined condition. The predetermined condition may be the requirement of the signal strength, the signal to noise ratio or the signal stability. If the UE measurement information UM satisfies the predetermined condition, then the process is terminated; if the UE measurement information UM does not satisfy the predetermined condition, then the process proceeds to step S130.

In one embodiment, the S110 and the step S120 may be omitted, and the method begins at steps S130 and S140.

Next, in the step S130, the controlling device 230 controls the first beam configuration device 210 to perform the antenna selection procedure on N antennas 260 to adjust the beam direction. The first beam configuration device 210 has a first configuration matrix F_{A}. F_{A}=[u₁ . . . u_{U}]. u₁ to u_{U} are U beamforming vectors. The controlling device 230 may adjust the first configuration matrix F_{A} to select some of the antennas 260 for controlling the beam direction, for instance U antennas.

Next, in the step S140, the controlling device 230 controls the second beam configuration device 220 to perform the phase shifting procedure to adjust the beam coverage. In the embodiment of FIG. 3, the second beam configuration device 220 includes L inputs I22, U outputs O22 and U*L phase shifters PS22. The L inputs I22 are connected to the L RF chains 250. The U outputs O22 are connected to the first beam configuration device 210. Each of the inputs I22 is connected to U of the U*L phase shifters PS22. Each of the outputs O22 is connected to L of the U*L phase shifters PS22.

That is to say, every U phase shifters PS22 are grouped to receive one of the RF chains 250. U*L phase shifters PS22 are classified into L groups, for receiving L RF chains 250. In each of the group including the U phase shifters PS22, the first phase shifter PS22 is connected to the first input I21 of the first beam configuration device 210, the second phase shifter PS22 is connected to the second input I21 of the first beam configuration device 210. Similarly, the Uth phase shifter PS22 is connected to the Uth input I21 of the first beam configuration device 210.

In each group including the U phase shifters PS22, the U phase shifters PS22 have different phase shift degrees. For example, the phase shift degrees of the U phase shifters PS22 in the first group are

$$[ \begin{matrix}{e}^{j {β}_{11}} \\ ⋮ \\ {e}^{j {β}_{U 1}}\end{matrix} ] .$$

The phase shift degrees of the U phase shifters PS22 in the Lth group are

$$[ \begin{matrix}{e}^{j {β}_{1 L}} \\ ⋮ \\ {e}^{j {β}_{U L}}\end{matrix} ] .$$

βᵤₗ is a phase setting value of the uth phase shifter PS22 in the lth group. The phase shift degrees of the U*L phase shifters PS22 form a second configuration matrix F_{B}.

$${F}_{B} = [ \begin{matrix}{e}^{j {β}_{11}} & … & {e}^{j {β}_{1 L}} \\ ⋮ & ⋱ & ⋮ \\ {e}^{j {β}_{U 1}} & … & {e}^{j {β}_{UL}}\end{matrix} ] .$$

The controlling device 230 may adjust the second configuration matrix F_{B} to adjust the energy distribution and control the beam coverage.

In one embodiment, the S130 and the S140 may be performed at the same time. The controlling device 230 may adjust the first configuration matrix F_{A} and the second configuration matrix F_{B} to obtain a suitable beam X. Refer to the equation (1), which illustrates the relationship among the beam X, the first configuration matrix F_{A} and the second configuration matrix F_{B}:

$$\begin{matrix}X = {F}_{A} {F}_{B} d \\ = [ \begin{matrix}{u}_{1} & … & {u}_{U}\end{matrix} ] [ \begin{matrix}{e}^{j {β}_{11}} & … & {e}^{j {β}_{1 L}} \\ ⋮ & ⋱ & ⋮ \\ {e}^{j {β}_{U 1}} & … & {e}^{j {β}_{UL}}\end{matrix} ] [ \begin{matrix}{d}_{1} \\ ⋮ \\ {d}_{L}\end{matrix} ] \\ = [ \begin{matrix}{\sum }_{i}^{U} {e}^{j {β}_{i 1}} {u}_{i} & … & {\sum }_{i}^{U} {e}^{j {β}_{iL}} {u}_{i}\end{matrix} ] [ \begin{matrix}{d}_{1} \\ ⋮ \\ {d}_{L}\end{matrix} ]\end{matrix} \qquad ( 1 )$$

According to the embodiments described above, the controlling device 230 controls the first beam configuration device 210 and the second beam configuration device 220 to perform the antenna selection procedure and the phase shifting procedure, such that the beam direction and the beam coverage can be controlled and the degree of freedom of the beam control is increased. As such, a precise beam can be obtained.

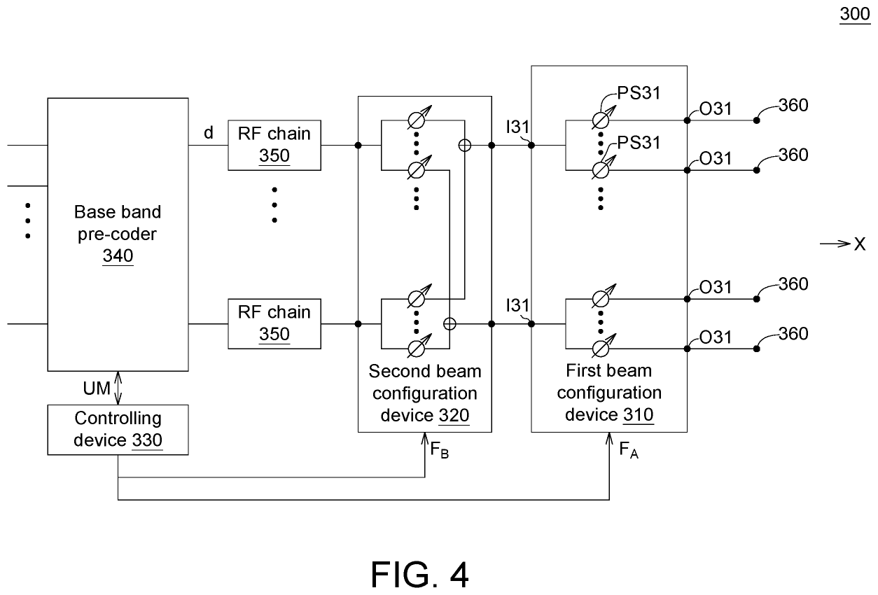

In another embodiment, the first beam configuration device 210 may not be the lens array. Please refer to FIG. 4, which shows a MIMO antenna system 300 according to another embodiment. In the embodiment of FIG. 4, a base band pre-coder 340 provides L RF chains 350, the precoded data matrix d of the L RF chain 350 is

$$[ \begin{matrix}{d}_{1} \\ ⋮ \\ {d}_{L}\end{matrix} ] .$$

The signals of the L RF chain 350 form a particular beam via a first beam configuration device 310 and a second beam configuration device 320. The first beam configuration device 310 may be a sub-array based phase shifter array, and the second beam configuration device 320 may be a fully-connected phase shifter array.

In the step S130, the controlling device 330 controls the first beam configuration device 310 to perform the antenna selection procedure on N antennas 360 to adjust the beam direction. The first beam configuration device 310 includes U inputs I31, N outputs O31 and N phase shifters PS31. The U inputs I31 are connected to the second beam configuration device 320. The N outputs O31 are connected to the N antennas 360. Each of the inputs I31 is connected to M of the N phase shifters PS31. M is less then N. Each of the outputs O31 is connected to one of the phase shifters PS31.

That is to say, every M of the phase shifters PS31 are grouped in one group. There are U*M phase shifters PS31. U*M=N. The first phase shifter PS31 is connected to the first antenna 360, and the second phase shifter PS31 is connected to the second antenna 360. Similarly, the Nth phase shifter PS31 is connected to the Nth antenna 360. The first beam configuration device 310 has a first configuration matrix F_{A}.

$${F}_{A} = [ \begin{matrix}{u}_{1} & … & 0 \\ ⋮ & ⋱ & ⋮ \\ 0 & … & {u}_{U}\end{matrix} ] .$$

The phase shift degrees of the M phase shifters PS31 in the first group is u₁.

$${u}_{1} = [ \begin{matrix}{e}^{j {∅}_{11}} \\ ⋮ \\ {e}^{j {∅}_{M 1}}\end{matrix} ] .$$

The phase shift degrees of the M phase shifters PS31 in the Uth group is u_{U}.

$${u}_{U} = [ \begin{matrix}{e}^{j {∅}_{1 U}} \\ ⋮ \\ {e}^{j {∅}_{MU}}\end{matrix} ] .$$

The controlling device 330 may adjust the first configuration matrix F_{A} to adjust the energy distribution and select some of the antennas 360, for instance U antennas, such that the beam direction can be controlled.

In the step S140, the controlling device 330 controls the second beam configuration device 320 to perform the phase shifting procedure to adjust the beam coverage. In the embodiment of FIG. 4, the second beam configuration device 320 is similar to the second beam configuration device 220 of FIG. 3, and the similarities are not repeated here.

The controlling device 330 may adjust the first configuration matrix F_{A} and the second configuration matrix F_{B} to obtain the suitable beam X. Refer to the equation (2), which illustrates the relationship among the beam X, the first configuration matrix F_{A} and the second configuration matrix F_{B}:

$$\begin{matrix}X = {F}_{A} {F}_{B} d \\ = [ \begin{matrix}{u}_{1} & … & 0 \\ ⋮ & ⋱ & ⋮ \\ 0 & … & {u}_{U}\end{matrix} ] [ \begin{matrix}{e}^{j {β}_{11}} & … & {e}^{j {β}_{1 L}} \\ ⋮ & ⋱ & ⋮ \\ {e}^{j {β}_{U 1}} & … & {e}^{j {β}_{UL}}\end{matrix} ] [ \begin{matrix}{d}_{1} \\ ⋮ \\ {d}_{L}\end{matrix} ] \\ = [ \begin{matrix}{e}^{j ( {∅}_{11} + {β}_{11} )} & & {e}^{j ( {∅}_{11} + {β}_{1 L} )} \\ ⋮ & … & ⋮ \\ {e}^{j ( {∅}_{M 1} + {β}_{11} )} & & {e}^{j ( {∅}_{M 1} + {β}_{1 L} )} \\ ⋮ & ⋱ & ⋮ \\ {e}^{j ( {∅}_{1 U} + {β}_{U 1} )} & & {e}^{j ( {∅}_{1 U} + {β}_{UL} )} \\ ⋮ & … & ⋮ \\ {e}^{j ( {∅}_{MU} + {β}_{U 1} )} & & {e}^{j ( {∅}_{MU} + {β}_{UL} )}\end{matrix} ] [ \begin{matrix}{d}_{1} \\ ⋮ \\ {d}_{L}\end{matrix} ]\end{matrix} \qquad ( 2 )$$

According to the embodiments described above, the controlling device 330 may control the first beam configuration device 310 and the second beam configuration device 320 to perform the antenna selection procedure and the phase shifting procedure, such that the beam direction and the beam coverage can be controlled and the degree of freedom of the beam control is increased. As such, a precise beam can be obtained.

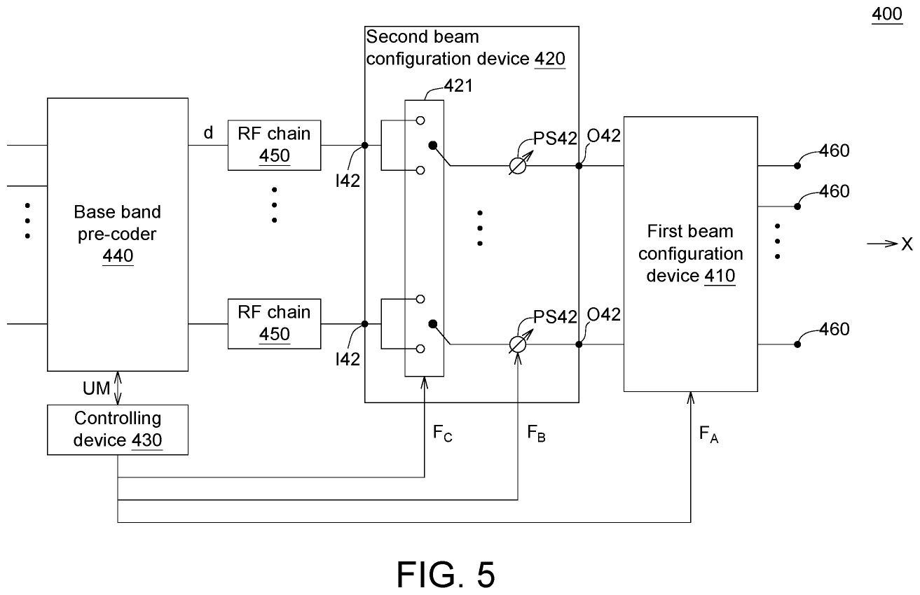

In another embodiment, the first beam configuration device 210 may not be the phase shifter array. Please refer to FIG. 5, which shows a MIMO antenna system 400 according to another embodiment. In the embodiment of FIG. 5, a base band pre-coder 440 provides L RF chains 450. The precoded data matrix d of the L RF chains 450 is

$$[ \begin{matrix}{d}_{1} \\ ⋮ \\ {d}_{L}\end{matrix} ] .$$

The signals of the L RF chains 450 form a particular beam via a first beam configuration device 410 and a second beam configuration device 420. In the embodiment of FIG. 5, the second beam configuration device 420 is a fully-switched phase shifter array.

In the step of S130, the controlling device 430 controls the first beam configuration device 410 to perform the antenna selection procedure on N antennas 460 to adjust the beam direction. The first beam configuration device 410 has a first configuration matrix F_{A}. F_{A}=[u₁ . . . u_{U}]. The controlling device 430 may adjust the first configuration matrix F_{A} to select some of the antennas 460, such that the beam direction can be controlled, for instance U antennas.

In the step S140, the controlling device 430 controls the second beam configuration device 420 to perform the phase shifting procedure to adjust the beam coverage. In the embodiment of FIG. 5, the second beam configuration device 420 includes L inputs I42, U outputs O42, a switch 421 and U phase shifters PS42. The L inputs I42 are connected to the L RF chains 450. The U outputs O42 are connected to the first beam configuration device 410. The switch 421 is connected between the L inputs I42 and the U phase shifters PS42. Each of the inputs I42 is connected to one of the U phase shifters PS42.

The switch 421 has a third configuration matrix F_{C}.

$${F}_{C} = [ \begin{matrix}{c}_{11} & … & {c}_{1 L} \\ ⋮ & ⋱ & ⋮ \\ {c}_{U 1} & … & {c}_{UL}\end{matrix} ] .$$

If the lth input I42 is connected to the Uth output O42, cᵤₗ=1; otherwise, cᵤₗ=0. Σₗ₌₁^{L} cᵤₗ=1. The controlling device 430 may controls the switch 421 via the third configuration matrix F_{C}, such that one of the RF chains 450 is inputted to the first beam configuration device 410 via one particular phase shifter PS42. Moreover, the U phase shifters PS42 have a second configuration matrix F_{B}.

$${F}_{B} = [ \begin{matrix}{e}^{j {∅}_{1}} & … & 0 \\ ⋮ & ⋱ & ⋮ \\ 0 & … & {e}^{j {∅}_{U}}\end{matrix} ] .$$

F_{B} is a diagonal matrix. The values on the diagonal line are the phase setting value of the U phase shifters PS42. The controlling device 430 may adjust the second configuration matrix F_{B} to adjust the energy distribution, such that the beam coverage can be controlled.

The controlling device 430 may adjust the first configuration matrix F_{A}, the second configuration matrix F_{B} and the third configuration matrix F_{C} to obtain the suitable beam X. Refer to the equation (3), which illustrates the relationship among the beam X, the first configuration matrix F_{A}, the second configuration matrix F_{B} and the third configuration matrix F_{C}:

$$\begin{matrix}X = {F}_{A} {F}_{B} {F}_{C} d \\ = [ \begin{matrix}{u}_{1} & … & {u}_{U}\end{matrix} ] [ \begin{matrix}{e}^{j {∅}_{1}} & … & 0 \\ ⋮ & ⋱ & ⋮ \\ 0 & … & {e}^{j {∅}_{U}}\end{matrix} ] [ \begin{matrix}{c}_{11} & … & {c}_{1 L} \\ ⋮ & ⋱ & ⋮ \\ {c}_{U 1} & … & {c}_{UL}\end{matrix} ] [ \begin{matrix}{d}_{1} \\ ⋮ \\ {d}_{L}\end{matrix} ] \\ = [ \begin{matrix}{v}_{1} & … & {v}_{L}\end{matrix} ] [ \begin{matrix}{d}_{1} \\ ⋮ \\ {d}_{L}\end{matrix} ]\end{matrix} \qquad ( 3 )$$

According to the embodiments described above, the controlling device 430 may control the first beam configuration device 410 and the second beam configuration device 420 to perform the antenna selection procedure and the phase shifting procedure, such that the beam direction and the beam coverage can be controlled and the degree of freedom of the beam control is increased. As such, a precise beam can be obtained.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A MIMO antenna system, comprising:
a first beam configuration device, used for performing an antenna selection procedure on a plurality of antennas to adjust a beam direction;
a second beam configuration device, connected to the first beam configuration device, wherein the second beam configuration device is used for performing a phase shifting procedure to adjust a beam coverage; and
a controlling device, used for controlling the first beam configuration device and the second beam configuration device.

2. The MIMO antenna system according to claim 1, wherein the first beam configuration device is a smart antenna array, a phase shifter array or a lens array.

3. The MIMO antenna system according to claim 1, wherein the second beam configuration device is a phase shifter array.

4. The MIMO antenna system according to claim 1, further comprising:
L RF chains, wherein the second beam configuration device is connected to the L RF chains; and
N antennas, wherein the first beam configuration device is connected to the N antennas, and the first beam configuration device selects U antennas from the N antennas.

5. The MIMO antenna system according to claim 4, wherein the second beam configuration device comprises:
L inputs, connected to the L RF chains;
U outputs, connected to the first beam configuration device; and
U*L phase shifters, wherein each of the inputs is connected to U of the U*L phase shifters, and each of the outputs is connected to L of the U*L phase shifters.

6. The MIMO antenna system according to claim 4, wherein the first beam configuration device is a phase shifter array, and the first beam configuration device comprises:
U inputs, connected to the second beam configuration device;
N outputs, connected to the N antennas; and
N phase shifters, wherein each of the inputs is connected to M of the N phase shifters, M is less than N, and each of the outputs is connected to one of the N phase shifters.

7. The MIMO antenna system according to claim 4, wherein the second beam configuration device comprises:
L inputs, connected to the L RF chains;
U outputs, connected to the first beam configuration device;
U phase shifters; and
a switch, connected among the L inputs and the U phase shifters, wherein each of the outputs is connected to one of the U phase shifters.

8. A controlling method of a MIMO antenna system, comprising:
controlling a first beam configuration device to perform an antenna selection procedure on a plurality of antennas to adjust a beam direction; and
controlling a second beam configuration device to perform a phase shifting procedure to adjust a beam coverage, wherein the second beam configuration device is connected to the first beam configuration device.

9. The controlling method of the MIMO antenna system according to claim 8, wherein the first beam configuration device is a smart antenna array, a phase shifter array or a lens array.

10. The controlling method of the MIMO antenna system according to claim 8, wherein the second beam configuration device is a phase shifter array.

11. The controlling method of the MIMO antenna system according to claim 8, wherein the MIMO antenna system further comprises N antennas and L RF chains, the second beam configuration device is connected to the L RF chains, the first beam configuration device is connected to the N antennas, the first beam configuration device selects U antennas from the N antennas.

12. The controlling method of the MIMO antenna system according to claim 11, wherein the second beam configuration device comprises L inputs, U outputs and U*L phase shifters, the L inputs are connected to the L RF chains, the U outputs are connected to the first beam configuration device, each of the inputs is connected to U of the U*L phase shifters, and each of the outputs is connected to L of the U*L phase shifters.

13. The controlling method of the MIMO antenna system according to claim 11, wherein the first beam configuration device is a phase shifter array, the first beam configuration device comprises U inputs, N outputs and N phase shifters, the U inputs are connected to the second beam configuration device, the N outputs are connected to the N antennas, each of the inputs is connected to M of the N phase shifters, M is less then N, and each of the outputs is connected to one of the N phase shifters.

14. The controlling method of the MIMO antenna system according to claim 11, wherein the second beam configuration device comprises L inputs, U outputs, U phase shifters and a switch, the L inputs are connected to the L RF chains, the U outputs are connected to the first beam configuration device, the switch is connected among the L inputs and the U phase shifters, and each of the outputs is connected to one of the U phase shifters.
